(19) United States
(12) Patent Application Publication
(10) Pub. No.: US 2006/0195272 A1
(43) Pub. Date: Aug. 31, 2006

(54) Real-time measuring system used for motor driver

(76) Inventor: Jia-Ming Wu, Taoyuan (TW)

Correspondence Address: HARNESS, DICKEY & PIERCE, P.L.C., P.O. BOX 8910, RESTON, VA, 20195, US

(21) Appl. No.: 11/196,244

(22) Filed: Aug. 4, 2005

(30) Foreign Application Priority Data
Feb. 16, 2005 (TW) 94104502

(51) Int. Cl. G06F 19/00

(52) U.S. Cl. 702/32

(57) ABSTRACT

A real-time measuring system of the motor driver is provided, comprising: a digital signal processor (DSP), which is used to digitalize the operation data of the motor driver, and output more than one measured data; an interface circuit, which is connected to the digital signal processor, and is used to receive the measured data output by the digital signal processor; a conversion device, which is connected to the interface circuit, and is used to convert the first signal compatible with the first communication port to the second signal compatible with the second communication port, and a terminal processing device, which is used to analyze and process the input measured data with a programmed interface and display the measured data synchronously, as such to achieve the measurement of the operation data of the motor driver real-time and continuously.

This Non-provisional application claims priority under 35 U.S.C. § 119(a) on Patent Application No(s). 094104502 filed in Taiwan on Feb. 16, 2005, the entire contents of which are hereby incorporated by reference.

### BACKGROUND OF THE INVENTION

1. Field of Invention

The invention relates to a real-time measuring system used for measuring and gathering the operation data of the motor driver, and in particular to a real-time motor driver measuring system.

2. Related Art

In recent years, the related industry in many countries have dedicated quite a lot of manpower, material, time, and money to the research and development for improving the functions and performances of the conventional motor system, in the hope of raising the technology level of this industry, so that the benefit obtained can be applied widely to the various other industries, such as, the automation, the semiconductor manufacturing, the machine tool, and the transportation industries. Conventionally, the technology of the motor control has met a bottleneck. It is restricted by the switching speed of the switches of the electronic power elements in the motor driver and the operation speed of the computer microprocessor, so that it is not capable of achieving a significant breakthrough in its entire system control. Until the recent 10 years, the rapid progress and development of the semiconductor industry had led to great advancement in the capabilities of high power electronics, so that the design and manufacturing of the high power motor is much easier to realize. In addition to its compact size, its better performance, its increased efficiency, and moreover, due to the ever increasing operation speed of the microprocessor used in the computer, the maturing technology of the single chip microprocessor, and the increasing volume of data processing, the various motor control theories may be realized. Presently, the academic and industrial sectors have actively engaged in the research and development of the motor driver, in particular to the research and development of the motor driver and its peripheral systems.

In real applications, in order to achieve certain specific functions, some parameters of the motor drivers have to be adjusted and regulated, such as, the operation voltage, the operation current, or its revolution speed. To facilitate the adjustment of its parameters, the motor driver is so designed that during its operations, the measured data of the motor driver is output in a digital or analog manner. Thus, the most frequently utilized design is to connect its output terminal to the oscilloscope, so that the operation of the motor can be monitored to determine if the operation of the motor system is capable of fulfilling the actual requirement.

Refer to FIG. 1 for the system block diagram of the measuring system of the first motor driver according to the prior art. As shown in FIG. 1, a motor driver 10 is connected to a motor device 20, the motor driver 10 is used to output control signals and is connected to an oscilloscope 30, which is used to display and indicate the operation conditions of the motor driver 10. The motor driver 10 is provided with a terminal for receiving analog signals. The oscilloscope 30 can be utilized by the user to inspect and examine the signal output by the motor driver to determine if the operation of the motor driver 10 has reached the predetermined conditions. However, the oscilloscope 30 is a rather expensive instrument, in addition, it is relatively sophisticated, thus requiring long time learning and practice to achieve its skillful operation and manipulation, and most important of all, it is pretty heavy and cumbersome. As such, it is not suitable for being widely used in the manufacturing factory for measuring purposes.

Next, refer to FIG. 2 for the system block diagram of the measuring system of the second motor driver according to the prior art. FIG. 2 shows that in the measuring system of the second motor driver, a motor driver 11 is connected to a motor device 21, the motor driver is used to output data and is connected to a computer device 41 through a serial communication port (RS232) 31. The computer device 41 is used to send a trigger signal to the motor driver 11, so that the computer programs stored in the motor driver 11 are instructed to retrieve the data required, and store it in a temporary memory 51 until it is full to its capacity. Then the computer device 41 is used to send a check-up instruction and instruct the motor driver 11 to start sending back the data required. Since the communication speed of the serial communication port 31 is 115200 bits/s, and the output data required must first be stored in the temporary memory 51, the time of the arrival of the transmitted back data is delayed, thus the returned measured data do not have the real-time effectiveness as required.

Therefore, the development and manufacturing of a practical real-time motor driver measuring system, which can be utilized to transmit the data back much faster to a processing device, is presently the most important task in this field.

### SUMMARY OF THE INVENTION

In view of the above-mentioned problems and shortcomings of the prior art, the object of the invention is to provide a real-time motor driver measuring system, which includes a digital signal processor (DSP), and is utilized to digitalize the operation data of the motor driver and output the measured data; an interface circuit, which is connected to said digital signal processor, and is used to receive the measured data output by said digital signal processor; a conversion device, which is connected to said interface circuit, and is utilized to convert the first signal compatible with the first communication port to the second signal compatible with the second communication port, and a terminal processing device, which is used to receive the input measured data, and analyze and process said data through a programmed interface to display said measured data synchronously, as such achieving the effectiveness of measuring the motor driver in a synchronous manner. In addition, since the display of the measured data does not require utilizing the oscilloscope, the real-time motor driver measuring system of the invention is made more applicable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is a system block diagram of the measuring system of the first motor driver of the prior art;

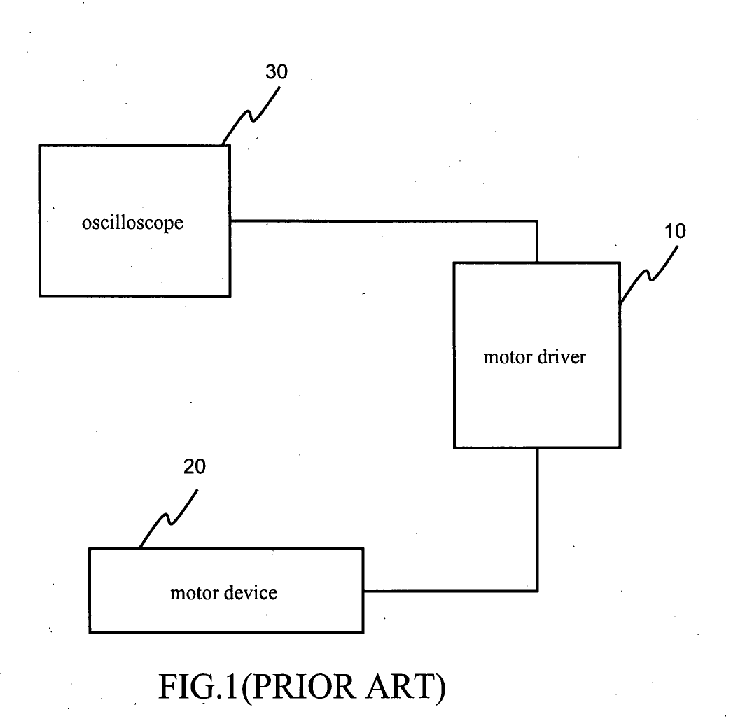

FIG. 2 is a system block diagram of the measuring system of the second motor driver of the prior art;

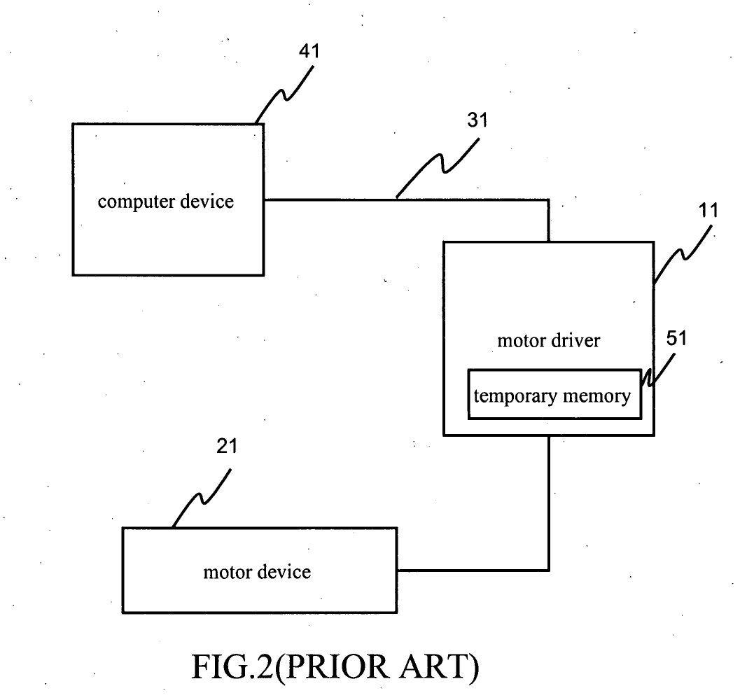

FIG. 3 is a system block diagram of the real-time measuring system of the first motor driver according to the first embodiment of the invention;

FIG. 4 is a system block diagram of the real-time measuring system of the second motor driver according to the second embodiment of the invention; and

FIG. 5 is a flow chart for multi-cable real-time measuring of the motor driver.

### DETAILED DESCRIPTION OF THE INVENTION

The purpose, construction, features, and functions of the present invention can be appreciated and understood more thoroughly through the following detailed description with reference to the attached drawings.

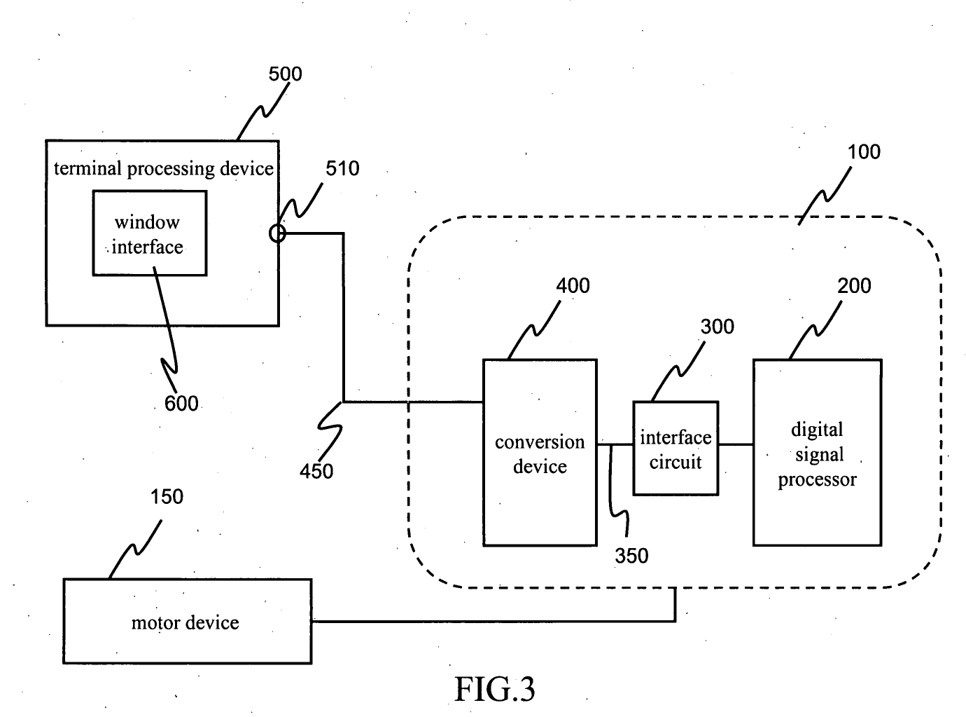

To begin with, refer to FIG. 3 for the system block diagram of the first real-time motor driver measuring system according to the first embodiment of the invention, in which the said real-time motor driver measuring system includes: a digital signal processor (DSP) 200, an interface circuit 300, a conversion device 400, and a terminal processor device 500.

As shown in FIG. 3, a motor driver 100 is provided, which is measured real time and is actually an AC motor driver, and is utilized to control the motor device 150 by means of the sine wave Pulse Width Modulation (PWM). The motor driver 100 is provided with a plurality of function keys (not shown) and a display (not shown), that can be utilized to provide the following functions: the user's setting of the operation frequency of the motor device 150, displaying the actual output frequency of the motor device 150, displaying the actual output current of the motor device 150, browsing the user's set parameters, revising the settings, locking the parameters, displaying the malfunctions, and executing the operation, the stop, the reset, the forward drive, the reverse drive, the minute drive, etc.

Furthermore, a digital signal processor (DSP) 200 is provided in the motor driver 100, which is utilized to digitalize the set parameters and the actual operation data of the motor driver 100, and output the measured data thus obtained, which is in fact a digital signal, therefore having the advantages of not being interfered with in the communication process as done by the prior art with the analog signal.

Moreover, in the data communication between the conversion device 400 and the digital signal processor (DSP) 200, an interface circuit 300 is required so that the signals transmitted are compatible with the specific data communications protocols.

As such, the digital signal output by the digital signal processor 200 is transmitted into a high speed serial communication port 350 via an interface circuit 300. The communication speed of such a high speed serial communication port 350 may reach more than 10 times the speed of the ordinary serial communication port of 115200 bits/s. In addition, one end of the conversion device 400 is connected to the interface 300, and the other end of the conversion device 400 is connected to the terminal processing device 500. Wherein its first communication port is connected to the interface circuit 300, and the second communication port is connected to the terminal processing device 500, as such the conversion device 400 is utilized to convert the first signal compatible with the first communication port to the second signal compatible with the second communication port. In one embodiment, the communication interface of the serial communication port (RS 232) is utilized for the first communication port, which is used for the output of the motor driver 100.

However, some of the new fashioned terminal processing device 500 or palm data processing device are not provided with an interface having the serial communication port (RS 232) used for serial connection. Besides, since the communication speed of the serial communication port (RS 232) is 115200 bits/s, and even though the speed of the high speed serial communication port can reach more than 10 times that speed, yet it is not as fast as that of the universal serial bus (USB) 450. Therefore, the conversion device 400 is utilized to provide the specification conversion between the first communication port and the second communication port. In one embodiment, a high speed serial communication port 350 is utilized as the first communication port, and a universal serial bus 450 is utilized as the second communication port. The above description is only used as an example to explain the communication port can be used for data transfer rate conversion, yet it is not intended to restrict the type of the first communication port and the second communication port. In the conversion device 400 is provided a chip used for data communication speed conversion from that of the high speed serial communication port (high speed RS 232) to that of the universal serial bus (USB). Upon conversion, if the universal serial bus 450 is of USB 1.1 standard, then its data communication speed is 12 Mb/s; however, if it is of USB 2.0 standard, then its data communication speed is 480 Mb/s, which is quite enough for the real-time communication.

The terminal processing device 500 is actually a computer system, yet it may be a palm type information processing system, which is provided with an insertion slot 510 for the universal serial bus, that is utilized by the universal serial bus 450 for connecting to the conversion device 400. A display device (not shown) is utilized in the terminal processing device 500 to display a window interface 600 in the software manner, which is connected to the motor driver 100, so that the parameter data of the plurality motor driver 100 can be displayed by means of the window interface 600. As such, the data may be displayed in a plurality of window systems, so that several users may monitor the operation of the motor driver 100 simultaneously. If any malfunction occurs, the motor driver 100 will send out the alarm signals to alert the users to take the necessary protection measures.

Naturally, for the well written program of the window interface 600, the capability is provided for adjusting the specific parameters of the motor driver by the users in addition to the monitoring capability provided as mentioned earlier. In the multi-window configuration, different parameters of the motor driver 100 may be displayed. Under this circumstance, the terminal processing device 500 is utilized to receive data continuously in one direction, and thus will not constitute an additional burden or workload for the digital signal processor 200. When it is discovered by the terminal processing device 500 that the received data contains errors after decoding, it will not request the motor driver 100 to resend the data, but merely mark the error on the screen and continue to display the next data. As such, in the multi-cable on-line display system, the terminal processing device 500 will not repeat the multi-cable synchronization, such, that it will not cause the delay of the input data, thus ensuring sufficient correctness of the measured data. Moreover, in the invention, it is not required to preset a temporary memory area in the motor driver 100 to use as a buffer for transmitting data. The built-in computer program of the motor driver 100 is used to take the initiative to periodically send out the measured data the user desires to examine or inspect. As such the number of the measured data is proportional to the duration of the time, and thus the number of the data points of the measured data is also proportional to the duration of the time, so that the motor driver 100 can be measured in a real-time manner.

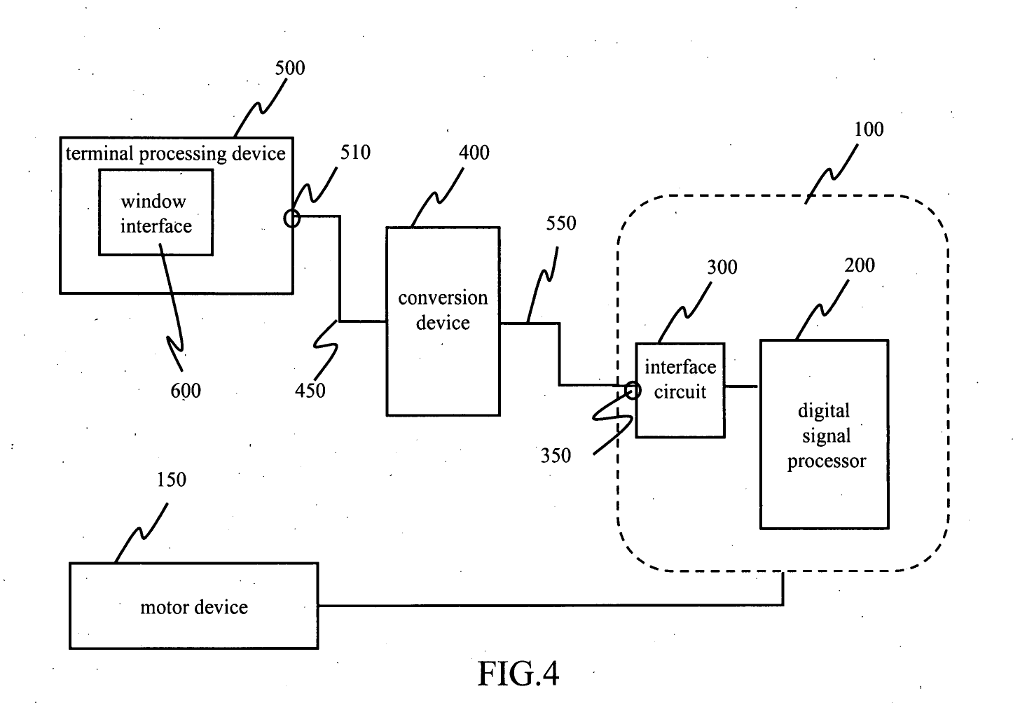

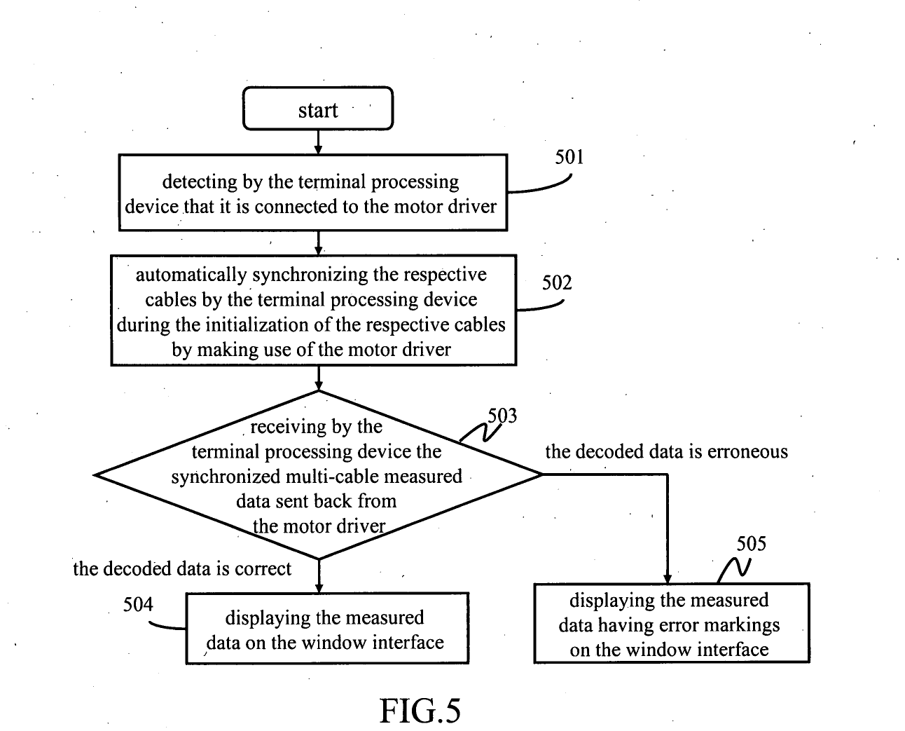

Finally, refer to FIG. 4 for the real-time measuring system of the second motor driver according to the second embodiment of the invention. In this embodiment, the conversion device 400 is not built in the motor driver 100, instead it is disposed outside the motor driver 100, with one side of said conversion device 400 connected to the high speed serial communication port 350 of the motor driver 100 via the connection wire 550, while the other side of said conversion device 400 is connected to the terminal processing device 500 via the connection wire 450. In addition, refer to FIG. 5 for the flowchart of the multi-cable real-time measuring of the motor driver of the invention. As shown in FIG. 5, firstly, the motor device and the motor driver are actuated. Next, in step 501, the terminal-processing device is used to detect if it is connected to the motor driver. Then, in step 502, the terminal processing device is used to automatically synchronize the time of the respective cables during their initialization by means of the motor driver. Subsequently, in step 503, the terminal processing device is used to receive the synchronous multi-cable measured data transmitted back from the motor driver; if the decoded measured data is correct, then the process flow proceeds to step 504, displaying the measured data on the window interface. Otherwise, if the decoded measured data is not correct, then the process flow proceeds to step 505, displaying the measured data having error markings on the screen of the window interface.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A real-time measuring system of the motor driver, comprising:
a digital signal processor (DSP), which is used to digitalize the operation data of said motor driver, and output more than one measured data;
an interface circuit, which is connected to said digital signal processor, and is used to receive said measured data output by said digital signal processor;
a conversion device, which is connected to said interface circuit, and is used to convert the first signal in compatible with the first communication port to the second signal in compatible with the second communication port; and
a terminal processing device, which is used to analyze and process said input measured data with a programmed interface, and display said measured data synchronously.

2. The real-time measuring system of the motor driver as claimed in claim 1, wherein said conversion device is built in said motor driver.

3. The real-time measuring system of the motor driver as claimed in claim 1, wherein said conversion device is disposed outside of said motor driver and connected through a connection wire.

4. The real-time measuring system of the motor driver as claimed in claim 1, wherein said first communication port is a high speed serial communication port (RS 232).

5. The real-time measuring system of the motor driver as claimed in claim 1, wherein said second communication port is a universal serial bus (USB).

6. The real-time measuring system of the motor driver as claimed in claim 5, wherein said universal serial bus is in compatible with the USB 1.1 standard of the communication protocol.

7. The real-time measuring system of the motor driver as claimed in claim 5, wherein said universal serial bus is in compatible with the USB 2.0 standard of the communication protocol.

8. The real-time measuring system of the motor driver as claimed in claim 1, wherein said programmed interface is utilized to display said measured data provided by the multi-cable.

9. The real-time measuring system of the motor driver as claimed in claim 1, wherein said measure data is a digital signal.
